(19) United States
(12) Patent Application Publication
(10) Pub. No.: US 2007/0261933 A1
(43) Pub. Date: Nov. 15, 2007

(54) Conveyor roller assembly and conveyor roller insert

(76) Inventor: C. Winfield Scott, Cincinnati, OH (US)

Correspondence Address: DINSMORE & SHOHL, LLP, 1900 CHEMED CENTER, 255 EAST FIFTH STREET, CINCINNATI, OH, 45202, US

(21) Appl. No.: 11/411,337

(22) Filed: Apr. 26, 2006

(51) Int. Cl. B65G 13/00

(52) U.S. Cl. 193/37

(57) ABSTRACT

A roller insert for a conveyor roller tube includes a cartridge, a stub axle positioned within the cartridge, at least one bearing mounted within the cartridge and supporting the axle such that the cartridge is rotatable with respect to the axle, and an annular sleeve configured to be inserted into an end of a conveyor roller tube. The cartridge is securely and non-rotatably positioned within the annular sleeve. A conveyor roller assembly is also provided.

### FIELD OF THE INVENTION

The present invention relates to the field of conveyor rollers and, more particularly, to conveyor rollers having stub shafts and conveyor roller inserts for mounting conveyor rollers to support frames.

### BACKGROUND OF THE INVENTION

Conveyor systems utilizing rollers are widely used in a variety of industrial applications. In a typical configuration, a plurality of closely spaced, freely-rotating conveyor rollers are mounted in parallel to an elongate support frame. The structure for mounting the rollers to the support frame is integral with the rollers. In some conveyor roller designs, inserts are mounted in each end of the roller tube and include protrusions projecting outwardly from the ends of the tube which are received within opposing pairs of mounting holes provided on the conveyor frame. Consequently, each conveyor roller assembly is independently attachable to and removable from the conveyor support frame.

Such a structure is advantageous in terms of flexibility of design and ease of maintenance. However, in order to provide rollers of different diameters or rollers having one end which is larger than the other (e.g., tapered rollers), manufacturers must produce inserts having a variety of outer diameters.

### SUMMARY OF THE INVENTION

One embodiment of the present invention provides a conveyor roller insert for a conveyor roller tube having:
(a) a cartridge having inner and outer ends;
(b) a stub axle positioned within the cartridge, the stub axle having inner and outer ends;
(c) at least one bearing mounted within the cartridge and supporting the axle such that the cartridge is rotatable with respect to the axle; and
(d) an annular sleeve configured to be inserted into an end of a conveyor roller tube,
the annular sleeve having inner and outer circumferences, and inner and outer ends;
   wherein the cartridge is securely and non-rotatably positioned within the annular sleeve.

Another embodiment of the present invention provides a conveyor roller, comprising an elongate roller tube having first and second ends and first and second roller inserts inserted into the first and second ends of the roller tube. Each of the roller inserts may comprise a cartridge, stub axle and at least one bearing, as described above. At least one (and optionally both) of the inserts further includes an annular sleeve configured to be inserted into an end of the roller tube, wherein the cartridge of that roller insert is securely and non-rotatably positioned within the annular sleeve.

The present invention also provides a conveyor roller having an elongate roller tube and a roller insert inserted into each end of the roller tube.

### BRIEF DESCRIPTION OF THE DRAWINGS

The following detailed description will be more fully understood in view of the drawings in which:

FIG. 1 is a cross-sectional view of a tapered conveyor roller assembly according to one embodiment of the present invention, wherein the center portion of the conveyor roller tube has been omitted;

FIG. 2 is a perspective view of an annular sleeve according to an embodiment of the present invention; and

FIG. 3 is a cross-sectional view of the annular sleeve of FIG. 2.

The embodiments set forth in the drawings are illustrative in nature and are not intended to be limiting of the invention defined by the claims. Moreover, individual features of the drawings and the invention will be more fully apparent and understood in view of the detailed description.

### DETAILED DESCRIPTION

The present invention is directed to conveyer roller assemblies and conveyor roller inserts for use in conveyor roller tubes. In particular embodiments, a conveyor roller insert is provided, wherein that insert includes not only a cartridge having a stub axle rotatably mounted therein, but also an annular sleeve within which the cartridge is securely positioned. The inner diameter of the annular sleeve is sized and configured so as to snugly receive the cartridge therein, while the outer diameter of the sleeve is sized and configured such that it may be secured within the open end of a roller tube. The outer diameter of the sleeve may be varied in order to accommodate roller tubes of different sizes, without altering the size or configuration of the cartridge or any of the additional components of the insert positioned within the cartridge. In this manner, the same cartridge assembly may be used in roller tubes of varying sizes simply by inserting the cartridge into an annular sleeve having the appropriate outer diameter.

Other embodiments of the present invention provide conveyor roller assemblies comprising a roller tube and a roller insert inserted into each end of the roller tube. One or both of the inserts may utilize the annular sleeve described above. In one particular embodiment comprising a tapered conveyor roller assembly wherein the inner diameter of the roller tube at one end is greater than the inner diameter at the opposite end, one of the inserts may include the annular sleeve (which effectively increases the outer diameter of the insert) while the other does not. Alternatively, each of the inserts may employ an annular sleeve, wherein one of the sleeves has a larger outer diameter than the other. In this manner, tapered conveyor roller assemblies may be provided wherein the cartridge, stub axle and bearing assemblies are identical to one another.

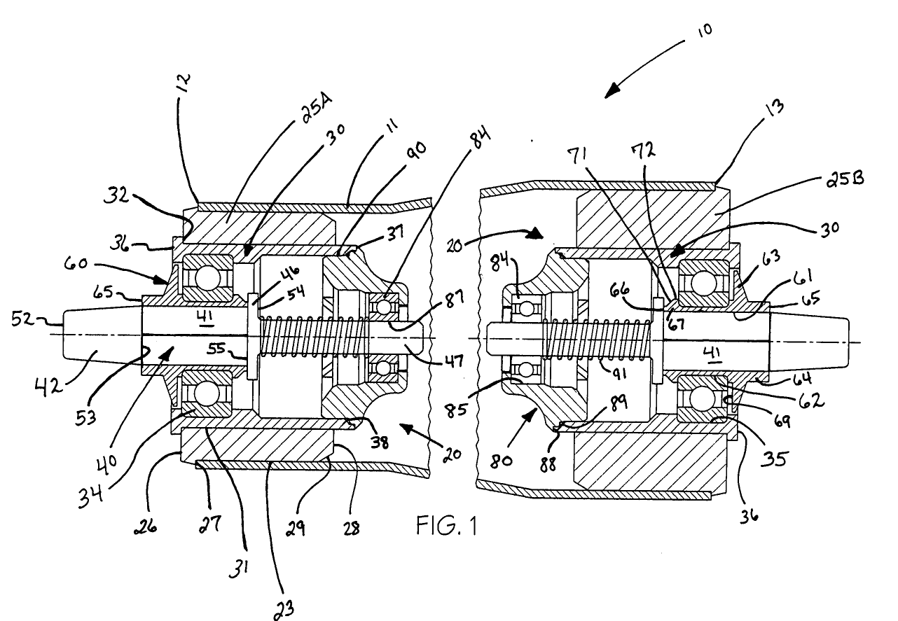

FIG. 1 depicts a cross-sectional view of an exemplary embodiment of a conveyor roller assembly 10 according to the present invention. Conveyor roller 10 generally includes a conveyor roller tube 11 having first and second open end portions 12 and 13. Conveyor roller tube 11 may be a tapered cylinder as shown, or may even comprise a straight or crowned cylinder, as is known to those skilled in the art. Conveyor roller inserts 20 having stub axles 40 rotatably mounted therein are secured within the first and second end portions of conveyor roller tube 11 such that conveyor roller tube 11 is rotatable relative to stub axles 40. As further described herein, stub axles 40 are also axially moveable with respect to conveyor roller tube 11 such that the outer end portion of stub axle 40 may be depressed inwardly (i.e., into the end portion of roller tube 11) for installation of the conveyor roller in a frame. The conveyor roller inserts shown in FIG. 1 are similar to those described and depicted in U.S. Pat. No. 7,028,825 (“the '825 patent”), as well as U.S. patent application Ser. No. 11/047,099 (“the '099 application,” filed Jan. 31, 2005), both of which are incorporated herein by way of reference.

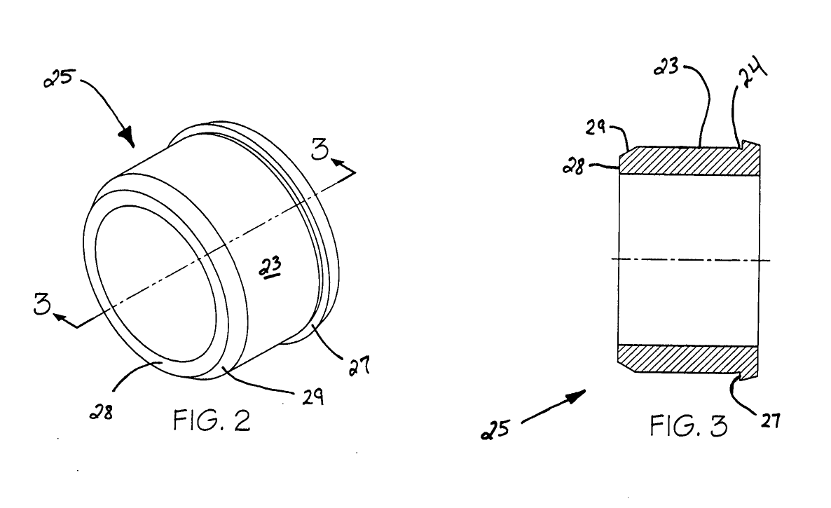

In the embodiment of FIG. 1, each conveyor roller insert 20 includes a tubular cartridge 30 which is secured within an annular sleeve 25, and the annular sleeve 25 is shaped to be fitted into the open end portions 12 and 13 of conveyor roller tube 11. Cartridge 30 includes a generally cylindrical sidewall 31, and inner and outer ends 37 and 36, respectively. Outer end 36 includes a lip 32 formed thereon. In the embodiments shown and described in the '825 patent and the '099 application, lip 32 on the cartridge is configured to engage and cover the end wall of conveyor roller tube 11 such that cartridge 30 may be press fit into the opened end portions of conveyor roller tube 11. In fact, as mentioned previously, some embodiments of conveyor rollers according to the present invention employ a conveyor roller insert similar to that shown, for example, in FIG. 2 of the '099 application at one end of the roller tube (i.e., without an annular sleeve).

In the embodiment shown in FIG. 1 herein, each cartridge 30 is press fit into an annular sleeve 25. For example, the outer diameter of cartridge 30 may be equal to or slightly less than the inner diameter of annular sleeve 25 such that cartridge 30 may be press fit into annular sleeve 25. Cartridge 30 is securely and non-rotatably positioned within annular sleeve 25. If needed, cartridge 30 may be secured within annular sleeve 25 using, for example, adhesives, heat welding, or other means known to those skilled to the art.

First and second annular sleeves 25A and 25B may be sized and configured to fit into the opened end portions 12 and 13, respectively, of conveyor tube 11. In particular, the outer diameter of annular sleeves 25A and 25B may be equal to or slightly less than the inner diameter of the end portions 12 and 13 of conveyor roller tube 11. In this manner, annular sleeves 25A and 25B may be securely and non-rotatably positioned within opposite ends of roller tube 11. Once again, adhesives, heat welding or other means known to those skilled in the art may be employed to ensure that annular sleeves 25 remain securely and non-rotatably positioned within the ends of roller tube 11.

In the embodiment shown in FIG. 3, sidewall 23 of sleeve 25 tapers inwardly adjacent lip 27 such that the open end portion of tube 11 may be crimped into the tapered groove formed by lip 27 and tapered portion 24 of sidewall 23. Although not shown in the attached figures, the sidewall of cartridge 30 may similarly be tapered adjacent lip 32, as further described in the '825 patent. As described in the '825 patent, when cartridge 30 is used without annular sleeve 25, the open end portion of roller tube 11 may be crimped into the tapered groove formed by lip 32 and the tapered portion of sidewall 31.

Sidewall 23 of annular sleeve 25 may also taper inwardly adjacent inner end 28 of the sleeve, as shown. Tapered portion 29 adjacent inner end wall 28 facilitates insertion of the annular sleeve into the end of roller tube 11 during assembly.

Cartridge 30 may also include a sloped shoulder 38 extending about the interior periphery adjacent inner end 37. As further described herein, and as described in the '825 patent, sloped shoulder 38 facilitates the attachment of a bearing retainer member 80 to the inner end 37 of cartridge 30.

Cartridge 30 further includes a bearing assembly 34 having inner and outer races and a ring of balls captured there between. The outer race of bearing assembly 34 is seated and captured within a groove 35 formed in the interior wall of cartridge 30 adjacent outer end 36. Since cartridge 30 (as well as sleeve 25) may be made from a polymeric material, such as an electrically conductive thermoplastic (e.g., electrically conductive polypropylene), cartridge 30 may be molded around bearing 34 in order to encapsulate and retain bearing 34 within cartridge 30.

As best seen in FIG. 1, stub axle 40 extends through the central passageway formed by the inner race of bearing 34 such that bearing 34 supports stub axle 40 and allows for the rotation of cartridge 30 with respect to axle 40. In the embodiment shown in FIG. 1, however, a bushing 60 is provided between stub axle 40 and bearing 34, as further described herein.

In the exemplary embodiment of FIG. 1, stub axle 40 includes an elongate body portion 41 and a tip portion 42 extending outwardly away from body portion 41. In the embodiment shown, elongate body portion 41 has a hexagonal cross-sectional shape, whereas tip portion 42 has a circular cross-sectional shape. However, these are merely exemplary, particularly since tip portion 42 may alternatively have a hexagonal or other polygonal cross-sectional shape. It should also be pointed out that stub axle 40 may be configured so as to include an end cap, particularly one having a hardness which is less than that of the tip portion of the axle, as described in the '825 patent.

In the embodiment shown in FIG. 1, the outer surface of tip portion 42 tapers such that the diameter of tip portion 42 at distal (or outer) end 52 is smaller than the diameter at proximal end 53. Of course tip portion 42 may be provided in a variety of shapes and sizes, such as a straight cylindrical shape rather than tapered.

As mentioned previously, a bushing 60 may be positioned within bearing 34, as seen in FIG. 1. Bushing 60 includes a central bore 61 which is shaped to slidably receive elongate body portion 41 of stub axle 40 therethrough. Thus, in the embodiment shown, central bore 60 has a hexagonal cross-sectional shape corresponding to that of body portion 41 of axle 40. In this manner, elongate body portion 41 of axle 40 may be positioned within central bore 61 of bushing 60 such that axle 40 is not capable of rotation with respect to bushing 60. However, axle 40 will be rotatable, along with bushing 60, with respect to cartridge 30, annular sleeve 25 and conveyor roller tube 11.

Bushing 60 also includes a circumferential groove 62 extending about its outer surface, wherein groove 62 is sized and configured such that the inner race of bearing 34 may be at least partially positioned within the groove 62. When positioned in this manner, the inner race of bearing 34 will essentially be attached to bushing 60 such that cartridge 30 is rotatable with respect to bushing 60.

Bushing 60 may further include a flange 63 located distally with respect to groove 62. Flange 63 is configured to cover and protect bearing 34, and may have an outer diameter slightly less than the inner diameter of outer end 36 of cartridge 30. In this manner, flange 63 will not interfere with the rotation of cartridge 30 with respect to bushing 60 and axle 40. In addition, flange 63 may be slightly spaced distally from groove 62 such that, when bushing 60 is installed as shown, a slight gap will exist between inner surface 69 of flange 63 and bearing 34. Bushing 60 may further include an extension 64 located between distal end surface 65 and flange 63. Extension 64 will provide additional support for axle 40, and its outer surface may have a hexagonal cross-sectional shape corresponding to the hexagonal shape of central bore 61.

At its proximal end, bushing 60 may be slotted such that a plurality of fingers 67 are provided. In particular, and as shown in FIGS. 6 and 7 of the '825 patent, a plurality of grooves 70 extend from proximal end 66 of bushing 60 in the axial direction. With respect to hexagonal central bore 61, grooves 70 are located on the flat portion of the hexagonal cross-section. In this manner, six fingers 67 are provided. When viewed in cross-section, the outer surface of each finger 67 will comprise a circular segment. The cross-sectional shape of the inner surface 68 of each finger 67 will be angular in nature, as best seen in the end view of FIG. 7 of the '825 patent.

In the embodiment shown in FIGS. 5-7 of the '825 patent, grooves 70 extend beyond the midpoint of outer circumferential groove 62. In addition, at least a portion of the inner surface 68 of fingers 67 taper outwardly, as indicated by angle A in FIG. 6 of the '825 patent. In the embodiment shown therein, inner surface 68 is not tapered along the entire length of each finger 67. In particular, inner surface 68 of finger 67, when viewed in the axial cross-section of FIG. 6 of the '825 patent, tapers outwardly from a line 72 spaced away from the base 73 of finger 67. In this manner, each finger 67 is cantilevered from line 72. In other words, each finger 67 includes a base portion having a non-tapered inner surface, and a cantilevered portion having a tapered inner surface.

Because the inner surface 68 of fingers 67 taper outwardly, a force applied axially against proximal end surface 66 of bushing 60 will cause fingers 67 to flex outwardly. For example, and as further described herein, axle 40 may include a flange 46 positioned such that flange 46 is biased against proximal end surface 66 of bushing 60. As fingers 67 of bushing 60 are urged outwardly, projections 72 which define the proximal end wall of groove 62 on bushing 60 will prevent bushing 60 from being forced out of roller insert 20. The proximal end wall 71 of projections 72 may be tapered in order to facilitate the insertion of bushing 60 into roller insert 20.

In the embodiment shown in FIG. 1, each roller insert may further include a second bearing 84 for further rotationally supporting axle 40 with respect to conveyor roller tube 11. In particular, second bearing 84 is provided in a bearing retainer assembly 80.

Bearing retainer assembly 80 is generally tubular in nature, and includes a central passageway 86. The outer race of bearing 84 is seated and captured within a groove 85 formed in the interior side wall of bearing retainer member 80. Like cartridge 30, bearing retainer assembly 80 may be made from a polymeric material, particularly an electrically conductive thermoplastic such as electrically conductive polypropylene. Therefore, bearing retainer assembly 80 may be molded around bearing 84 in order to encapsulate and retain bearing 84 therein. The inner race of bearing 84 defines a central passageway 87 which is sized and configured to slidingly receive and support a rod portion 47 provided an axle 40, as further described herein.

On its outer surface, bearing retainer assembly 80 includes an outer lip 88 extending about the outer circumference of bearing retaining assembly 80. Outer lip 88 is sized and configured such that bearing retainer assembly 80 may be inserted into the inner end portion of cartridge 30 with lip 88 seated against inner end wall 37 of cartridge 30. A shoulder 89 is also provided, and is spaced distally from lip 88. When bearing retainer assembly 80 is inserted into the inner end portion of cartridge 30, shoulder 89 will abut against sloped shoulder 38 on cartridge 30. This configuration will facilitate the welding (such as by sonic welding) of bearing retainer assembly 80 to the inner end portion of cartridge 30. Furthermore, bearing retainer assembly 80 includes a distal end portion 90 having a cylindrical outer surface. Distal end portion 90 is sized and configured to be snugly received into the inner end portion of cartridge 30, as shown in FIG. 1. It should also be noted that the outer circumference of bearing retainer assembly 80 at lip 88 may be equal to or slightly less than the outer circumference of cartridge 30 at inner end wall 37.

Stub axle 40 may include a rod portion 47 extending away from elongate body portion 41 at the proximal end thereof. The proximal or inner end 48 of rod portion 47 may also be tapered as shown in order to facilitate insertion of rod portion 47 into central passageway 87 formed by the inner race of second bearing 84. Rod portion 47 is sized and configured to be slidably received in central passageway 87. In this manner, the inner race of second bearing 84 will support rod portion 47 while still allowing slidable movement of the axle relative to both first bearing 34 and second bearing 84. Second bearing 84 will also facilitate rotational movement of cartridge 30 relative to axle 40.

As mentioned previously, axle 40 may be biased outwardly from cartridge 30 such that the outer end portion of the axle will project outwardly from outer end 36 of cartridge 30. However, the outer end portion of the axle can be urged inwardly in order to facilitate insertion of the outer end portion of the axle into a mounting hole on a conveyor frame.

In the embodiment shown, axle 40 further includes a flange 46 located between elongate body portion 41 and rod portion 47. In the embodiment shown, flange 46 may be any of a variety of shapes. However, the outer diameter of flange 46 should be greater than the outer diameter of bushing 60 at proximal end surface 66. In the exemplary embodiment shown, flange 46 has a circular cross-sectional shape.

As best seen in FIG. 1, flange 46, specifically the proximal or inner surface 54 of flange 46, provides a seat for a biasing member, such as a coil spring 91. Coil spring 91 encircles rod portion 47 of axle 40, and is seated against the inner race of second bearing 84. In this manner, coil spring 91 will bias axle 40 outwardly (i.e., in the distal direction). Outer or distal end surface 55 of flange 46 is urged against proximal end surface 66 of bushing 60 by coil spring 91. Thus, bushing 60 acts as a limit or stop, preventing the outward travel of axle 40 from cartridge 30 beyond a preselected distance. At the same time, flange 46 will cause fingers 67 of busing 60 to flex outwardly, thereby preventing bushing 60 from being forced out of cartridge 30.

In the embodiment shown in FIG. 1, the conveyor roller insert 20 is configured such that axle 40 is biased outwardly to the extent that proximal end 53 of tip portion 42 is normally approximately aligned with distal end surface 65 of bushing 60. In this manner, only tip portion 42 of axle 40 is exposed. The outer end portion of axle 40 (i.e., tip portion 42) may be urged inwardly into bushing 60. When mounted in a conveyor frame, bushing 60 will not enter the mounting hole on the frame. Therefore, the outer end portion of axle 40 need not be urged inwardly beyond distal end surface 65 of bushing 60.

All of the components of conveyor roller insert 20 may be made from electrically conductive materials. For example, axle 40, other than end cap 50, may be made from a metal such as steel. As mentioned previously, end cap 50 may be made from an electrically conductive polymeric material such as electrically conductive polyurethane. Cartridge 30, annular sleeve 25, bushing 60 and bearing retainer assembly 80 may also be made from an electrically conductive polymeric material, such as an electrically conductive thermoplastic (e.g., electrically conductive, glass-reinforced polypropylene). Of course any of a variety of other materials may be used for each of these components.

The conveyor rollers of the present invention may also include sound-absorptive material within the roller tube, as further described in the '099 application.

The specific illustrations and embodiments described herein are exemplary only in nature and are not intended to be limiting of the invention defined by the claims. Further embodiments and examples will be apparent to one of ordinary skill in the art in view of this specification and are within the scope of the claimed invention.

What I claim is:

1. A roller insert for a conveyor roller tube, comprising:
(a) a cartridge having inner and outer ends;
(b) a stub axle positioned within said cartridge, said stub axle having inner and outer ends;
(c) at least one bearing mounted within said cartridge and supporting said axle such that said cartridge is rotatable with respect to said axle; and
(d) an annular sleeve configured to be inserted into an end of a conveyor roller tube, said annular sleeve having inner and outer circumferences, and inner and outer ends;
wherein said cartridge is securely and non-rotatably positioned within said annular sleeve.

2. The roller insert of claim 1, wherein said axle is slidable with respect to said bearing, and said axle is biased outwardly from said cartridge such that said outer end of the axle projects outwardly from the outer end of the cartridge and the outer end of the sleeve.

3. The roller insert of claim 1, wherein the outer surface of said sleeve tapers inwardly adjacent the inner end thereof in order to facilitate insertion of the sleeve into the end of a roller tube.

4. The roller insert of claim 1, wherein said sleeve includes a lip extending around the outer circumference thereof adjacent the outer end of the sleeve, wherein said sleeve may be inserted into the end of a conveyor roller tube such that the lip abuts against the outer end wall of the roller tube.

5. The roller insert of claim 1, comprising a pair of bearings mounted within said cartridge and supporting said axle such that said cartridge is rotatable with respect to said axle and said axle is slidable with respect to said bearings.

6. The roller insert of claim 5, further comprising a bushing mounted within said bearing, said bushing having a central bore, wherein a portion of said axle is slidingly positioned within said central bore of said bushing.

7. The roller insert of claim 6, further comprising a coil spring which biases said axle.

8. A conveyor roller, comprising an elongate roller tube having first and second ends and first and second roller inserts inserted into said first and second ends of the roller tube, respectively, each of said roller inserts comprising:
(a) a cartridge having inner and outer ends;
(b) a stub axle positioned within said cartridge, said stub axle having inner and outer ends; and
(c) at least one bearing mounted within said cartridge and supporting said axle such that said cartridge is rotatable with respect to said axle;
wherein at least one roller insert further comprises an annular sleeve configured to be inserted into an end of the roller tube, said annular sleeve having inner and outer circumferences, and inner and outer ends, and further wherein the cartridge of said at least one roller insert is securely and non-rotatably positioned within said annular sleeve.

9. The conveyor roller of claim 8, wherein each of said roller inserts includes said annular sleeve.

10. The conveyor roller of claim 9, wherein the first end of the roller tube has an inner diameter which is greater than the inner diameter of the second end of the roller tube, and further wherein the outer diameter of the sleeve of the first insert is greater than the outer diameter of the sleeve of the second insert.

11. The conveyor roller of claim 10, wherein said roller tube comprises a tapered tube.

12. The conveyor roller of claim 10, wherein the outer diameter of the cartridges of the first and second inserts are the same, and further wherein the inner diameter of the cartridges of the first and second inserts are the same.

13. The conveyor roller of claim 10, wherein the outer surface of the first and second sleeves tapers inwardly adjacent the inner end of the sleeves in order to facilitate insertion of the sleeve into the ends of the roller tube.

14. The conveyor roller of claim 10, wherein each of said sleeves includes a lip extending around the outer diameter of the sleeve adjacent the outer end of the sleeve, said sleeves inserted into the ends of the roller tube such that the lips on each sleeve abut against the outer end walls of the roller tube.

15. The conveyor roller of claim 8, wherein only the first roller insert includes said annular sleeve.

16. The conveyor roller of claim 15, wherein the first end of the roller tube has an inner diameter which is greater than the inner diameter of the second end of the roller tube, and further wherein the outer diameter of the sleeve of the first insert is greater than the outer diameter of the cartridge of the second insert.

17. The conveyor roller of claim 16, wherein said roller tube comprises a tapered tube.

18. The conveyor roller of claim 16, wherein the outer diameter of the cartridges of the first and second inserts are the same, and further wherein the inner diameter of the cartridges of the first and second inserts are the same.

19. The conveyor roller of claim 16, wherein the outer surface of the sleeve tapers inwardly adjacent the inner end of the sleeve in order to facilitate insertion of the sleeve into the first end of the roller tube.

20. The conveyor roller of claim 16, wherein said sleeve includes a lip extending around the outer diameter of the sleeve adjacent the outer end of the sleeve, said sleeve inserted into the first end of the roller tube such that the lip on the sleeve abuts against the outer end wall of the roller tube.
